(19) United States
(12) Patent Application Publication
(10) Pub. No.: US 2014/0072045 A1
(43) Pub. Date: Mar. 13, 2014

(54) IMAGE PROCESSING APPARATUS, IMAGE PROCESSING SYSTEM, AND COMPUTER-IMPLEMENTED METHOD FOR PROCESSING IMAGE DATA

(71) Applicant: KABUSHIKI KAISHA TOSHIBA, Tokyo (JP)

(72) Inventors: Shuou NOMURA, Yokohama-Shi (JP); Hajime MATSUI, Yokohama-Shi (JP)

(73) Assignee: Kabushiki Kaisha Toshiba, Tokyo (JP)

(21) Appl. No.: 13/774,670

(22) Filed: Feb. 22, 2013

(30) Foreign Application Priority Data
Sep. 12, 2012 (JP) 2012-200479

(51) Int. Cl. H04N 7/26

(52) U.S. Cl. CPC H04N 19/00721
USPC 375/240.16

(57) ABSTRACT

According to one embodiment, an image processing apparatus includes a motion estimator, a motion vector converter, a motion compensation unit, a scaling unit, and a reconstructor. The motion estimator receives input image data including plural frames to generate a first motion vector indicating a correspondence between pixels on target and reference frames. The motion vector converter converts the first motion vector into a second motion vector indicating a correspondence between a pixel on an interpolated frame that interpolates the frames and the pixel on the reference frame. The motion compensation unit performs frame interpolation to the input image data using the second motion vector to generate motion compensation data comprising plural interpolated frames. The scaling unit scales the input image data to generate scaled image data. The reconstructor reconstructs the scaled image data using the motion compensation data to generate output image data.

### CROSS REFERENCE TO RELATED APPLICATION(S)

This application is based upon and claims the benefit of priority from the prior Japanese Patent Application No. 2012-200479, filed on Sep. 12, 2012, the entire contents of which are incorporated herein by reference.

### FIELD

Embodiments described herein relate generally to an image processing apparatus, an image processing system, and a computer-implemented method for processing image data.

### BACKGROUND

Nowadays, a technology called reconstruction-based super-resolution is well known as a method for estimating a high-resolution image from a low-resolution image. Generally the reconstruction-based super-resolution is one of pieces of scaling that is of image enlarging. However, because the reconstruction-based super-resolution is frequently used in combination with frame interpolation, it is assumed that the reconstruction-based super-resolution described herein is the processing including not only the scaling but also the frame interpolation (that is, the scaling and the frame interpolation are performed in the reconstruction-based super-resolution).

In the scaling, motion estimation in which a motion vector is generated from input image data, interpolated pixel estimation in which an interpolated pixel is estimated from the motion vector, the enlarging in which enlarged image data is generated from the input image data, and reconstruction in which reconstructed image data is generated from the enlarged image data and the interpolated pixel are performed.

In the frame interpolation, motion estimation in which the motion vector is generated from the reconstructed image data, interpolated frame estimation in which an interpolated frame is estimated from the motion vector, and motion compensation in which output image data is generated from the interpolated frame are performed.

However, in the conventional reconstruction-based super-resolution, the motion estimation of the scaling and the motion estimation of the frame interpolation are separately performed, it is necessary to perform the motion estimation plural times. As a result, a calculation amount increases in the reconstruction-based super-resolution.

Particularly, because the reconstructed image data is generated from the enlarged image data, the motion estimation is performed to the reconstructed image data corresponding to the enlarged image data, and the calculation amount increases.

### BRIEF DESCRIPTION OF THE DRAWINGS

FIG. 1 is a block diagram of an image processing system 1 of the embodiment.

FIG. 2 is an explanatory view of the input image data IMGin of the embodiment.

FIG. 3 is a block diagram of the image processing apparatus 10 of the embodiment.

FIG. 4 is an explanatory view of an operation example of the interpolation image data generator 16 of the embodiment.

FIG. 5 is an explanatory view of an operation example of the motion estimator 11 of the embodiment.

FIG. 6 is an explanatory view of an operation example of the motion vector converter 12 of the embodiment.

FIG. 7 is an explanatory view of an operation example of the second motion compensator 14 of the embodiment.

FIGS. 8A and 8B are explanatory views of modification of the embodiment.

### DETAILED DESCRIPTION

Embodiments will now be explained with reference to the accompanying drawings.

In general, according to one embodiment, an image processing apparatus includes a motion estimator, a motion vector converter, a motion compensation unit, a scaling unit, and a reconstructor. The motion estimator receives input image data including a plurality of frames to generate a first motion vector indicating a correspondence between a pixel on a target frame and a pixel on a reference frame. The motion vector converter converts the first motion vector into a second motion vector. The second motion vector indicates a correspondence between a pixel on an interpolated frame that interpolates the frames and the pixel on the reference frame. The motion compensation unit performs frame interpolation to the input image data using the second motion vector to generate motion compensation data comprising a plurality of interpolated frames. The scaling unit scales the input image data to generate scaled image data. The reconstructor reconstructs the scaled image data using the motion compensation data to generate output image data.

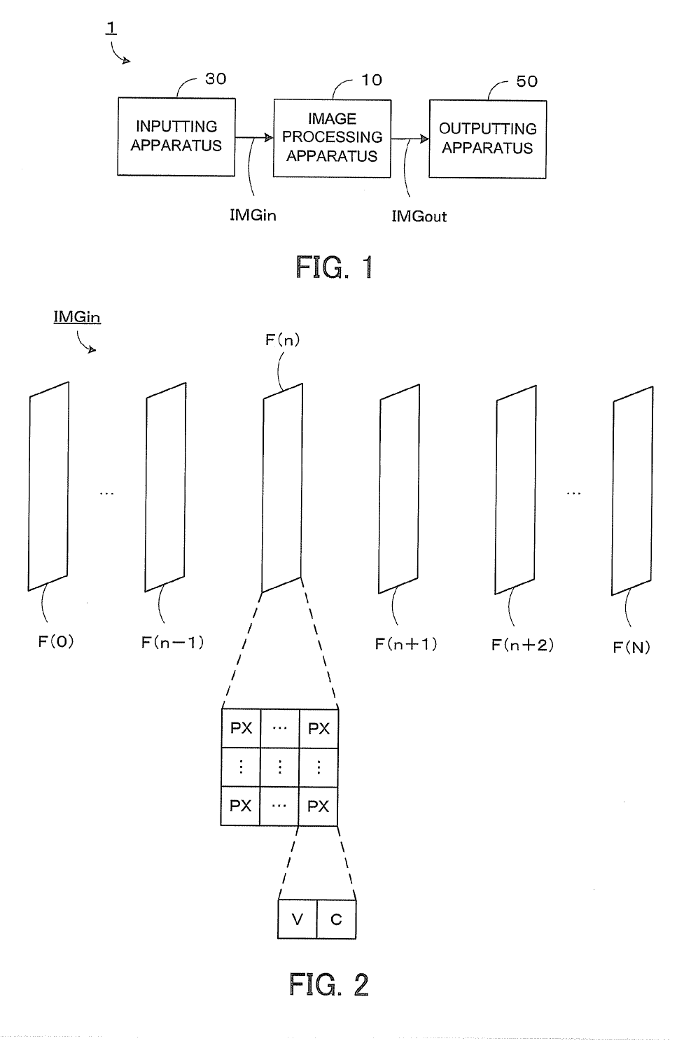

An embodiment will be described with reference to the drawings. FIG. 1 is a block diagram of an image processing system 1 of the embodiment. The image processing system 1 includes an image processing apparatus 10, an image inputting apparatus 30, and an image outputting apparatus 50. The image inputting apparatus 30 is a decoder (for example, an MPEG (Motion Picture Expert Group) decoder) that decodes coded data to generate input image data IMGin or a memory in which an input image data IMGin is stored. For example, the input image data is motion image data having an RGB format or a YUV format. The image processing apparatus 10 is a device that generates output image data IMGout from the input image data IMGin. The image outputting apparatus 50 is a device (for example, a liquid crystal display) that outputs the output image data IMGout generated by the image processing apparatus 10.

FIG. 2 is an explanatory view of the input image data IMGin of the embodiment. The input image data IMGin includes plural frames F(n) {n=0 to N (N is a positive integer)}. The frame F(n) includes plural pixels PX. Each pixel PX includes a pixel value V and coordinate information C. For example, the pixel value V is a value of RGB in the case of the RGB format, and is luminance and chrominance in the case of the YUV format.

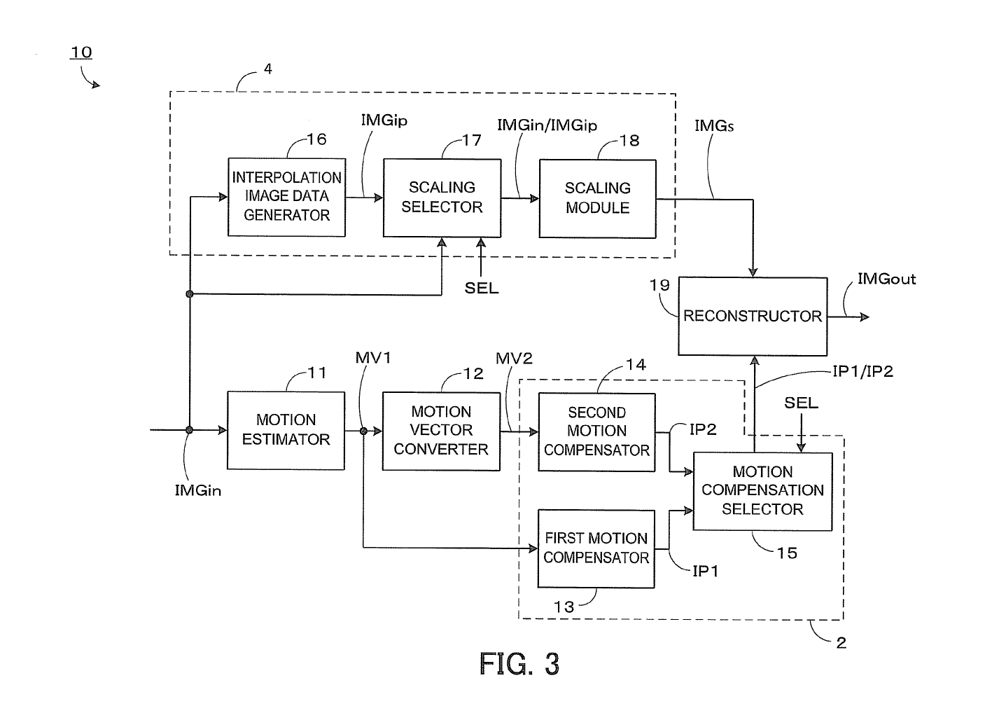

FIG. 3 is a block diagram of the image processing apparatus 10 of the embodiment. The image processing apparatus 10 includes a motion estimator 11, a motion vector converter 12, a motion compensation unit 2, a scaling unit 4, and a reconstructor 19.

The motion compensation unit 2 performs the frame interpolation to the input image data IMGin to generate motion compensation data (first or second motion compensation data IP1 or IP2). The motion compensation unit 2 includes first and second motion compensators 13 and 14 and a motion compensation selector 15.

The scaling unit 4 performs the scaling to the input image data IMGin to generate scaled image data IMGs. The scaling unit 4 includes an interpolation image data generator 16, a scaling selector 17, and a scaling module 18.

Hereinafter a frame F(n) to which the reconstruction-based super-resolution should be applied is referred to as a “target frame, and frames F(n−1) and F(n+1) that should be referred to in the reconstruction-based super-resolution are referred to as a “reference frame”.

The motion estimator 11 generates a first motion vector MV1, which is a motion estimation target between the target frame and the reference frame, in each frame of the input image data IMGin. The first motion vector MV1 means a vector that indicates motion of an image from the reference frame onto the target frame (that is, the frame included in the input image data IMGin). The first motion vector MV1 indicates a correspondence between a pixel on the target frame and a pixel on the reference frame with respect to all the pixels of the target frame. That is, the number of first motion vectors MV1 is a product of the number of pixels of the target frame and the number of reference frames. A vector quantity of the first motion vector MV1 corresponds to motion magnitude of a pixel V from the reference frame to the target frame, and a vector direction of the first motion vector MV1 corresponds to a motion direction of the pixel V from the reference frame to the target frame. The first motion vector MV1 is obtained with decimal pixel precision. For example, the motion estimator 11 generates the first motion vector MV1 by a block matching method or a gradient method.

The motion vector converter 12 converts the first motion vector MV1 into a second motion vector MV2. The second motion vector MV2 means a vector that indicates the motion of the image from the reference frame onto an interpolated frame Fip different from the reference frame. The vector quantity of the second motion vector MV2 corresponds to the motion magnitude of the pixel V from the reference frame to the interpolated frame Fip, and the vector direction of the second motion vector MV2 corresponds to the motion direction of the pixel V from the reference frame to the interpolated frame Fip. The interpolated frame Fip is not included in the input image data IMGin.

The interpolation image data generator 16 performs relatively simple frame interpolation (for example, blending) to the input image data IMGin to generate scaling interpolated image data IMGip. The scaling interpolated image data IMGip means image data that includes an interpolated frame, which interpolates plural frames included in the input image data IMGin.

The scaling selector 17 selects one of the input image data IMGin and the scaling interpolated image data IMGip based on a selection signal SEL. The selection signal SEL means a binary signal supplied from an inside or an outside of the image processing apparatus 10. For example, the scaling selector 17 selects the input image data IMGin in the case that the selection signal SEL is “0”, and selects the scaling interpolated image data IMGip in the case that the selection signal SEL is “1”. That is, the scaling selector 17 selects the input image data IMGin in the case that the frame of the input image data IMGin is obtained, and the scaling selector 17 selects the scaling interpolated image data IMGip in the case that the interpolated frame is obtained.

The scaling module 18 performs the scaling to the output (that is, one of the input image data IMGin and the scaling interpolated image data IMGip) of the scaling selector 17 to generate the scaled image data IMGs. The scaled image data IMGs means tentative image data before the reconstruction performed by the reconstructor 19. For example, a bi-linear filter, a bi-cubic filter, or a linear interpolation filter is applied in the scaling. The scaled image data IMGs is enlarged image data with respect to the input image data IMGin in the case that a scaling factor is greater than 1, the scaled image data IMGs is image data having the same size as the input image data IMGin in the case that the scaling factor is 1, and the scaled image data IMGs is contracted image data with respect to the input image data IMGin in the case that a scaling factor is less than 1.

The first motion compensator 13 generates first motion compensation data IP1 using the first motion vector MV1 and the pixel value of the corresponding reference frame. The first motion compensation data IP1 includes sets of decimal-precision coordinates and pixel values on the scaled image data IMGs. The pixel value is identical to the pixel value of the reference frame. The coordinate is obtained from the first motion vector MV1 that is of information indicating the corresponding position of the reference frame pixel on the scaled image data IMGs. That is, the first motion compensation data IP1 means data that defines the pixel (that is, an element of the input image data IMGin that is not included in the scaled image data IMGs) of the input image data IMGin, which is lost in the scaling.

The second motion compensator 14 generates second motion compensation data IP2 using the second motion vector MV2 and the pixel value of the reference frame. The second motion compensation data IP2 includes sets of decimal-precision coordinates and pixel values on the scaled image data IMGs. The pixel value is identical to the pixel value of the reference frame. The coordinate is obtained from the second motion vector MV2 that is of information indicating the corresponding position of the reference frame pixel on the interpolated scaled image data IMGs.

The motion compensation selector 15 selects one of the first and second pieces of motion compensation data IP1 and IP2 as the interpolated image data the based on the selection signal SEL. The selection signal SEL is identical to the selection signal SEL supplied to the scaling selector 17. The motion compensation selector 15 selects the first motion compensation data IP1 in the case that the scaling selector 17 selects the input image data IMGin (in the case that the selection signal SEL is “0”), and the motion compensation selector 15 selects the second motion compensation data IP2 in the case that the scaling selector 17 selects the scaling interpolated image data IMGip (in the case that the selection signal SEL is “1”).

The reconstructor 19 performs reconstruction (for example, the reconstruction is Maximum a Posteriori (MAP) or Projection Onto Convex Sets (POCS)) to the scaled image data IMGs (that is, the data in which the input image data IMGin or the scaling interpolated image data IMGip is enlarged or contracted) using the output (that is, the first or second motion compensation data IP1 or IP2) of the motion compensation selector 15, and generates the output image data IMGout.

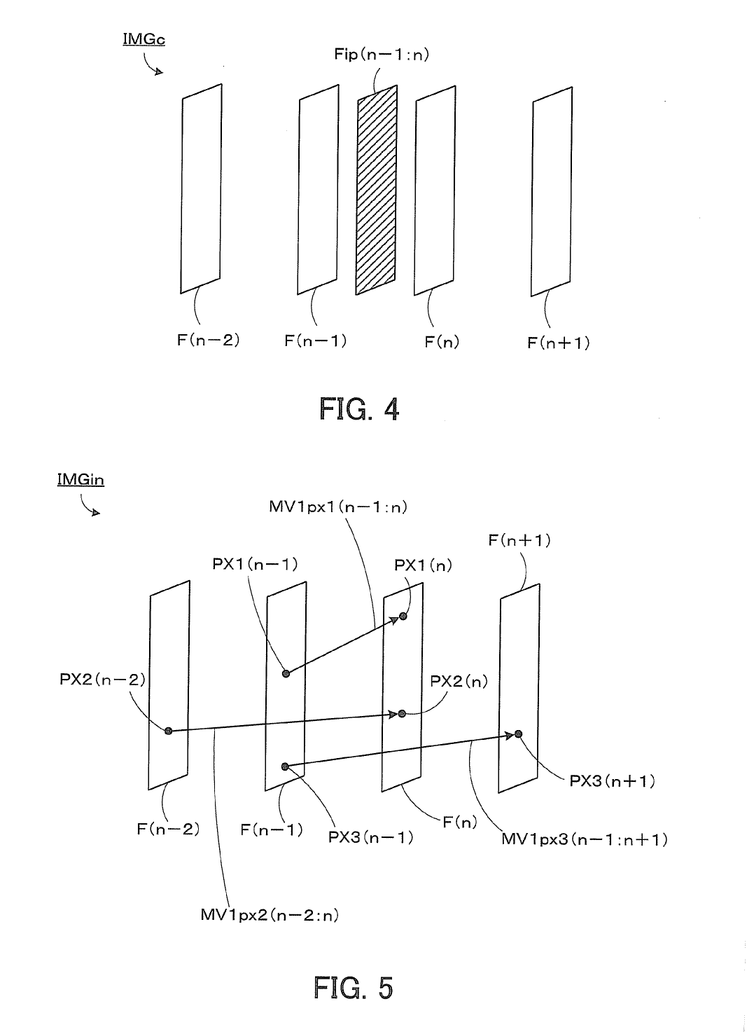

An operation example of the interpolation image data generator 16 will be described below. FIG. 4 is an explanatory view of an operation example of the interpolation image data generator 16 of the embodiment. For example, the interpolation image data generator 16 generates an interpolated frame Fip(n−1:n) by calculating an average of two adjacent frames F(n−1) and F(n) included in the input image data IMGin. The interpolated frame Fip(n−1:n) is a frame that interpolates the images of the frames F(n−1) and F(n). The scaling interpolated image data IMGip includes the frame F included in the input image data IMGin and the interpolated frame Fip.

An operation example of the motion estimator 11 will be described below. FIG. 5 is an explanatory view of an operation example of the motion estimator 11 of the embodiment. A first motion vector MV1(n) is a set of plural first pixel motion vectors MV1px. The first pixel motion vector MV1px indicates a correspondence (for example, a change in position with decimal precision) between the pixel on the reference frame and the pixel on the target frame.

The motion estimator 11 predicts a pixel PX1(n) on the target frame F(n), which corresponds to a pixel PX1(n−1) on the reference frame F(n−1), and calculates a first pixel motion vector MV1px1(n−1:n) indicating the correspondence between the pixel PX1(n−1) and the pixel PX1(n).

The motion estimator 11 also predicts a pixel PX2(n) on the target frame F(n), which corresponds to a pixel PX2(n−2) on the reference frame F(n−2), and calculates a first pixel motion vector MV1px2(n−2: n) indicating the correspondence between the pixel PX2(n−2) and the pixel PX2(n).

The motion estimator 11 also predicts a pixel PX3(n+1) on the target frame F(n+1), which corresponds to a pixel PX3(n−1) on the reference frame F(n−1), and calculates a first pixel motion vector MV1px3(n−1:n+1) indicating the correspondence between the pixel PX3(n−1) and the pixel PX3(n+1).

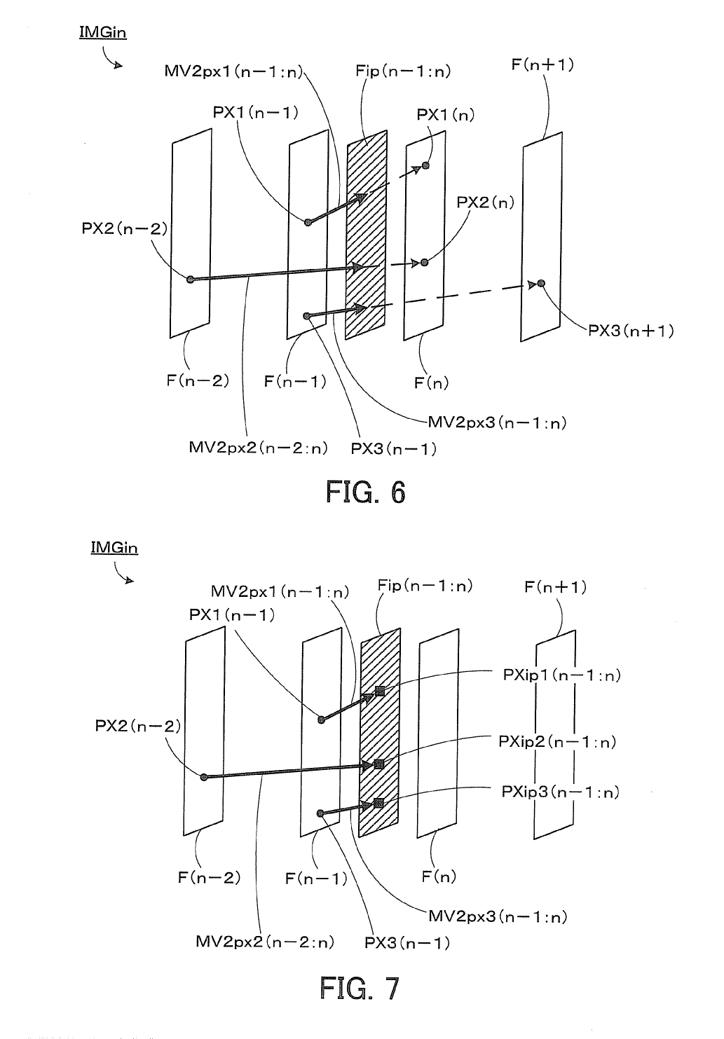

An operation example of the motion vector converter 12 will be described below. FIG. 6 is an explanatory view of an operation example of the motion vector converter 12 of the embodiment. FIG. 6 illustrates an example in which a second motion vector MV2(n) of the target frame F(n) is generated using the reference frames F(n−2) and F(n−1) (that is, the second vector MV2 is generated by the interpolation). The second motion vector MV2(n) is a set of plural second pixel motion vectors MV2px. The second pixel motion vector MV2px indicates a correspondence (for example, the change in position with decimal precision) between the pixel on the reference frame and the pixel on the interpolated frame.

The motion vector converter 12 calculates a second pixel motion vector MV2px1(n−1:n) indicating the correspondence between the pixel PX1(n−1) and the pixel on the interpolated frame Fip(n−1:n) based on the first pixel motion vector MV1px1(n−1:n) and a position on a temporal axis of the interpolated frame Fip(n−1:n).

The motion vector converter 12 also calculates a second pixel motion vector MV2px2(n−2:n) indicating the correspondence between the pixel PX2(n−2) and the pixel on the interpolated frame Fip(n−1:n) based on the first pixel motion vector MV1px2(n−2:n) and the position on the temporal axis of the interpolated frame Fip(n−1:n).

The motion vector converter 12 also calculates a second pixel motion vector MV2px3(n−1:n) indicating the correspondence between the pixel PX3(n−1) and the pixel on the interpolated frame Fip(n−1:n) based on the first pixel motion vector MV1px3(n−1:n+1) and the position on the temporal axis of the interpolated frame Fip(n−1:n).

An operation example of the second motion compensator 14 will be described below. FIG. 7 is an explanatory view of an operation example of the second motion compensator 14 of the embodiment. FIG. 7 illustrates an example in which the second motion compensation data IP2 corresponding to the interpolated frame Fip(n−1:n) is generated. The second motion compensation data IP2 defines the position of the pixel on the interpolated frame Fip(n−1:n).

The second motion compensator 14 calculates the position of a second interpolated pixel PXip1(n−1:n) on the interpolated frame Fip(n−1:n) using the pixel PX1(n−1) and the second pixel motion vector MV2px1(n−1:n).

The second motion compensator 14 also calculates the position of a second interpolated pixel PXip2(n−2:n) on the interpolated frame Fip(n−1:n) using the pixel PX2(n−2) and the second pixel motion vector MV2px2(n−2:n). The second motion compensator 14 also calculates the position of a second interpolated pixel PXip3(n−1:n) on the interpolated frame Fip(n−1:n) using the pixel PX3(n−1) and the second pixel motion vector MV2px3(n−1:n).

Unless the configuration of the image processing apparatus 10 is provided, the scaling and the frame interpolation are independently performed. At this point, the motion estimation is performed in each of the scaling and the frame interpolation.

On the other hand, in the embodiment, before the reconstructor 19 performs the reconstruction, the motion estimator 11 generates the first motion vector MV1, and the motion vector converter 12 generates the second motion vector MV2, so that the calculation amount can be reduced in the reconstruction-based super-resolution.

According to the embodiment, the motion compensation unit 2 and the scaling unit 4 are selectively operated, so that the reconstruction for the plural frames (that is, the target frame and the reference frame) included in the input image data IMGin and the reconstruction for the interpolated frame that is not included in the input image data IMGin can be performed by one module (the reconstructor 19).

In the conventional reconstruction-based super-resolution, because the motion estimation is performed in the frame interpolation after the reconstruction is performed in the scaling, the motion estimation is performed to the image data, which is obtained through the reconstruction and includes a noise. As a result, unfortunately quality of the output image is degraded.

On the other hand, in the embodiment, the motion estimator 11 performs the motion estimation to the input image data IMGin (that is, the data before the reconstruction performed by the reconstructor 19). Therefore, the quality of the output image can be improved better than ever before.

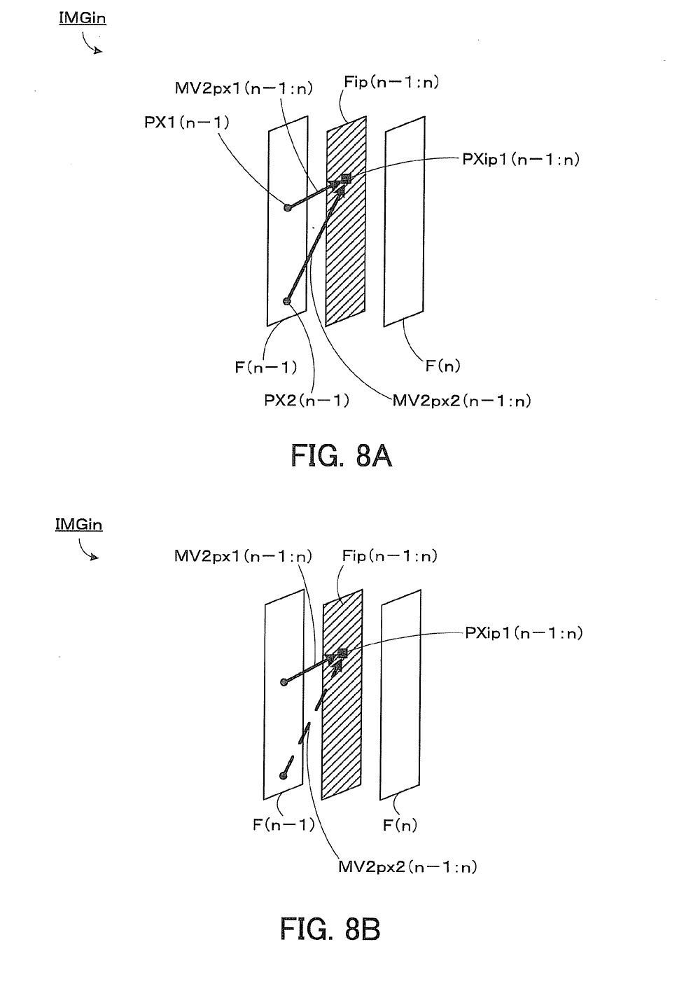

A modification of the embodiment will be described below. FIGS. 8A and 8B are explanatory views of modification of the embodiment. As illustrated in FIG. 8A, the modification is an example of the case that the second interpolated pixel PXip1(n−1:n) calculated using the pixel PX1(n−1) and the second pixel motion vector MV2px1(n−1:n) agrees with the second interpolated pixel PXip1(n−1:n) calculated using the pixel PX2(n−1) and the second pixel motion vector MV2px2(n−1:n) (that is, the second interpolated pixels overlap with each other).

In this case, as illustrated in FIG. 8B, the second motion compensator 14 calculates the second motion compensation data IP2 using the second motion vector (for example, the second motion vector MV2px1(n−1:n)) correlated with the pixel on the reference frame. The second motion vector is most similar to the second interpolated pixel PXip1(n−1:n), which is calculated by an SAD (Sum of Absolute Difference) method, in the corresponding second motion vectors MV2px1(n−1:n) and MV2px2(n−1: n).

According to the modification of the embodiment, only the second motion vector, which is most similar to the calculated second interpolated pixel and is correlated with the pixel on the reference frame, is used to calculate the second motion compensation data IP2. Therefore, the image quality of the output image data IMGout can be improved compared with the embodiment.

In the case that the second interpolated pixels overlap with each other, instead of FIG. 8B, the second motion compensator 14 may eliminate the generation of the second motion compensation data IP2 with respect to the interpolated frame in which the overlapping second interpolated pixel exists. Therefore, a processing amount of the image processing apparatus 10 (particularly, the second motion compensator 14) can be reduced compared with the embodiment.

In the embodiment, by way of example, the second motion vector MV2 is generated by the interpolation in FIG. 6. Alternatively, the second motion vector MV2 may be generated by extrapolation. The extrapolation indicates the case that the interpolated frame does not exist between the target frame and the reference frame (that is, the interpolated frame is inserted on the side opposite from the reference frame with respect to the target frame). For example, in FIG. 6, the interpolated frame Fip(n−1:n) is inserted based on the first motion vector MV1 when the frame F(n−2) is used as the reference frame while the frame F(n−1) is used as the target frame. In this case, the second motion vector MV2, namely, the insertion position of the interpolated frame Fip(n−1:n) is obtained by increasing the motion vector MV1 by half.

In the embodiment, by way of example, both the input image data IMGin and the output image data IMGout correspond to the progressive image. Alternatively, the input image data IMGin may correspond to the interlace image while the output image data IMGout corresponds to the progressive image (that is, the image processing apparatus 10 may include an IP (Interlace-Progressive) conversion function from the interlace image to the progressive image). For example, the scaling module 18 sets the vertical scaling factor double the horizontal scaling factor in the scaling, and the motion estimator 11 generates the first motion vector MV in consideration of a change between the position of the pixel on the reference frame and the position of the pixel on the target frame. Therefore, the IP conversion function can be implemented.

In the embodiment, by way of example, the two reference frames is used. However, the invention is not limited to the two reference frames. In the invention, at least three reference frames (for example, reference frames F(n−2), F(n−1), F(n+1), and F(n+2)) may be used.

At least a portion of the image processing system 1 according to the above-described embodiments may be composed of hardware or software. When at least a portion of the image processing system 1 is composed of software, a program for executing at least some functions of the image processing system 1 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the image processing system 1 according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An image processing apparatus comprising:
a motion estimator configured to receive input image data comprising a plurality of frames to generate a first motion vector indicating a correspondence between a pixel on a target frame and a pixel on a reference frame;
a motion vector converter configured to convert the first motion vector into a second motion vector, the second motion vector indicating a correspondence between a pixel on an interpolated frame that interpolates the frames and the pixel on the reference frame;
a motion compensation unit configured to perform frame interpolation to the input image data using the second motion vector to generate motion compensation data comprising a plurality of interpolated frames;
a scaling unit configured to scale the input image data to generate scaled image data; and
a reconstructor configured to reconstruct the scaled image data using the motion compensation data to generate output image data.

2. The apparatus of claim 1, wherein the motion compensation unit comprises:
a first motion compensator configured to generate first motion compensation data using the first motion vector and a pixel value of the reference frame;
a second motion compensator configured to generate second motion compensation data using the second motion vector and the pixel value of the reference frame; and
a motion compensation selector configured to select one of the first motion compensation data and the second motion compensation data as the motion compensation data.

3. The apparatus of claim 2, wherein the scaling unit comprises:
an interpolation image data generator configured to perform frame interpolation to the input image data to generate interpolated image data;
a scaling selector configured to select one of the input image data and the interpolated image data; and
a scaling module configured to scale the selected data to generate the scaled image data.

4. The apparatus of claim 2, wherein the first motion compensation data defines a pixel of the input image data, the defined pixel being lost in scaling of the scaling module.

5. The apparatus of claim 1, wherein the motion vector converter converts the first motion vector into the second motion vector using a plurality of reference frames closed to the target frame.

6. An image processing system comprising:
a decoder configured to decode coded data, and generate input image data comprising a plurality of frames;
a motion estimator configured to receive the input image data to generate a first motion vector indicating a correspondence between a pixel on a target frame and a pixel on a reference frame;
a motion vector converter configured to convert the first motion vector into a second motion vector, the second motion vector indicating a correspondence between a pixel on an interpolated frame that interpolates the frames and the pixel on the reference frame;
a motion compensation unit configured to perform frame interpolation to the input image data using the second motion vector to generate motion compensation data comprising a plurality of interpolated frames;
a scaling unit configured to scale the input image data to generate scaled image data; and
a reconstructor configured to reconstruct the scaled image data using the motion compensation data to generate output image data.

7. The system of claim 6, wherein the motion compensation unit comprises:
a first motion compensator configured to generate first motion compensation data using the first motion vector and a pixel value of the reference frame;
a second motion compensator configured to generate second motion compensation data using the second motion vector and the pixel value of the reference frame; and
a motion compensation selector configured to select one of the first motion compensation data and the second motion compensation data as the motion compensation data.

8. The system of claim 7, wherein the scaling unit comprises:
an interpolation image data generator configured to perform frame interpolation to the input image data to generate interpolated image data;
a scaling selector configured to select one of the input image data and the interpolated image data; and
a scaling module configured to scale the selected data to generate the scaled image data.

9. The system of claim 7, wherein the first motion compensation data defines a pixel of the input image data, the defined pixel being lost in scaling of the scaling module.

10. The system of claim 6, wherein the motion vector converter converts the first motion vector into the second motion vector using a plurality of reference frames closed to the target frame.

11. The system of claim 6, further comprising an outputting apparatus configured to output the output image data.

12. The system of claim 11, wherein the outputting apparatus is a display.

13. A computer-implemented method for processing image data, the method comprising:
receiving input image data comprising a plurality of frames to generate a first motion vector indicating a correspondence between a pixel on a target frame and a pixel on a reference frame;
converting the first motion vector into a second motion vector, the second motion vector indicating a correspondence between a pixel on an interpolated frame that interpolates the frames and the pixel on the reference frame;
performing frame interpolation to the input image data using the second motion vector to generate motion compensation data comprising a plurality of interpolated frames;
scaling the input image data to generate scaled image data; and
reconstructing the scaled image data using the motion compensation data to generate output image data.

14. The method of claim 13, wherein in the frame interpolation, first motion compensation data is generated using the first motion vector and a pixel value of the reference frame, second motion compensation data is generated using the second motion vector and the pixel value of the reference frame, and one of the first motion compensation data and the second motion compensation data is selected as the motion compensation data.

15. The method of claim 14, wherein in scaling the input image data, frame interpolation to the input image data is performed to generate interpolated image data, one of the input image data and the interpolated image data is selected, and the selected data is scaled to generate the scaled image data.

16. The method of claim 14, wherein the first motion compensation data defines a pixel of the input image data, the defined pixel being lost in scaling of the scaling module.

17. The method of claim 13, wherein in converting the first motion vector, the first motion vector is converted into the second motion vector using a plurality of reference frames closed to the target frame.
